(19) United States
(12) Patent Application Publication
(10) Pub. No.: US 2010/0205039 A1
(43) Pub. Date: Aug. 12, 2010

(54) DEMAND FORECASTING

(75) Inventors: Jayanta Basak, New Delhi (IN); Sameep Mehta, New Delhi (IN); Vinayaka D. Pandit, New Delhi (IN); Gyana Ranjan Parija, South City (IN)

Correspondence Address: RYAN, MASON & LEWIS, LLP, 1300 POST ROAD, SUITE 205, FAIRFIELD, CT, 06824, US

(73) Assignee: International Business Machines Corporation, Armonk, NY (US)

(21) Appl. No.: 12/369,418

(22) Filed: Feb. 11, 2009

(51) Int. Cl. G06Q 10/00

(52) U.S. Cl. 705/10

(57) ABSTRACT

At least a first future external event is obtained as input. At least one future effect of the at least one future external event is predicted. The at least first future external event is similar to at least a first past external event. Future utilization of at least one tangible resource is forecast by superimposing events-normalized forecasted data and the at least one predicted future effect of the at least one future event similar to the at least first past external event.

### FIELD OF THE INVENTION

The present invention relates to the electrical, electronic and computer arts, and, more particularly, to demand forecasting and the like.

### BACKGROUND OF THE INVENTION

Demand forecasting is the process of determining what products or services are needed in the future, in what quantities and at what time. It is quite important for effective planning of resources. For example, a contact center needs to forecast the call volume on an hourly basis for effective scheduling of agents.

U.S. Pat. No. 7,080,026 of Singh et al. discloses systems and methods for demand forecasting that enable multiple-scenario comparisons and analyses by letting users create forecasts from multiple history streams (for example, shipments data, point-of-sale data, customer order data, return data, etc.) with various alternative forecast algorithm theories. The multiple model framework of Singh et al. enables users to compare statistical algorithms paired with various history streams (collectively referred to as “models”) so as to run various simulations and evaluate which model will provide the best forecast for a particular product in a given market. Once the user has decided upon which model it will use, it can publish forecast information provided by that model for use by its organization (such as by a downstream supply planning program). Embodiments provide a system and method whereby appropriate demand responses can be dynamically forecasted whenever given events occur, such as when a competitor lowers the price on a particular product (such as for a promotion), or when the user's company is launching new sales and marketing campaigns. Preferred embodiments use an automatic tuning feature to assist users in determining optimal parameter settings for a given forecasting algorithm to produce the best possible forecasting model.

### SUMMARY OF THE INVENTION

Principles of the invention provide techniques to enhance forecasting systems to take into account the effects of external events in the context of resource planning. In one aspect, an exemplary method for forecasting (which can be computer-implemented) includes the steps of obtaining as input at least a first future external event; and predicting at least one future effect of the at least one future external event. The at least first future external event is similar to at least a first past external event. Also included is forecasting future utilization of at least one tangible resource by superimposing events-normalized forecasted data and the at least one predicted future effect of the at least one future event similar to the at least first past external event.

One or more embodiments of the invention or elements thereof can be implemented in the form of a computer product including a tangible computer readable storage medium with computer usable program code for performing the method steps indicated. Furthermore, one or more embodiments of the invention or elements thereof can be implemented in the form of an apparatus including a memory and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s), or (ii) a combination of hardware and software modules; any of (i)-(iii) implement the specific algorithms set forth herein.

One or more embodiments of the invention may offer one or more of the following technical benefits:
(i) Technically, often it is very difficult to automatically model the effect of external events which are irregular in nature. One or more embodiments of the present invention separate the events from the underlying time-series and model these events separately.
(ii) This provides a scope for further investigation into various kinds of event modeling, event learning, and event superposition.

These and other features, aspects and advantages of the present invention will become apparent from the following detailed description of illustrative embodiments thereof, which is to be read in connection with the accompanying drawings.

### BRIEF DESCRIPTION OF THE DRAWINGS

FIG. 1 shows a prior art forecasting system;

FIG. 2 shows an exemplary system, according to an aspect of the invention;

FIG. 3 shows an exemplary forecasting system enhancing apparatus, according to another aspect of the invention;

FIG. 4 shows an exemplary events detector, according to still another aspect of the invention;

FIG. 5 shows an exemplary events learner, according to yet another aspect of the invention;

FIG. 6 shows an exemplary events re-constructor, according to a further aspect of the invention;

FIGS. 7-17 show non-limiting examples of data from an embodiment of the invention;

FIGS. 18 and 19 presents flow charts of exemplary method steps, according to yet another additional aspect of the invention; and

FIG. 20 depicts a computer system that may be useful in implementing one or more aspects and/or elements of the invention.

### DETAILED DESCRIPTION OF PREFERRED EMBODIMENTS

Our analysis of historical call data revealed several interesting patterns, such as sporadic increases in call volume, zero or almost no calls on certain days, and so on. A further analysis showed that there is a strong correlation between sporadic increase in call volumes and new product releases, and similar correlation between football (i.e., soccer) matches in Europe and zero or no calls during those periods. One or more embodiments of the invention are able to effectively address these kinds of phenomena, unlike out-of-the-box forecasting approaches.

The pattern of demand seen by service providers that have a significant fraction of their volume realized by individual customers is very different from those that deal only with large organizations with long-term contracts. Examples of such service providers are contact centers, various rental agencies, the retail sector, and the like. Typically, their demand is impacted by various external events such as holiday season, sports season, weather seasons, disastrous events, political events, and so on. One or more embodiments of the invention account for the effects of external events during demand forecasting.

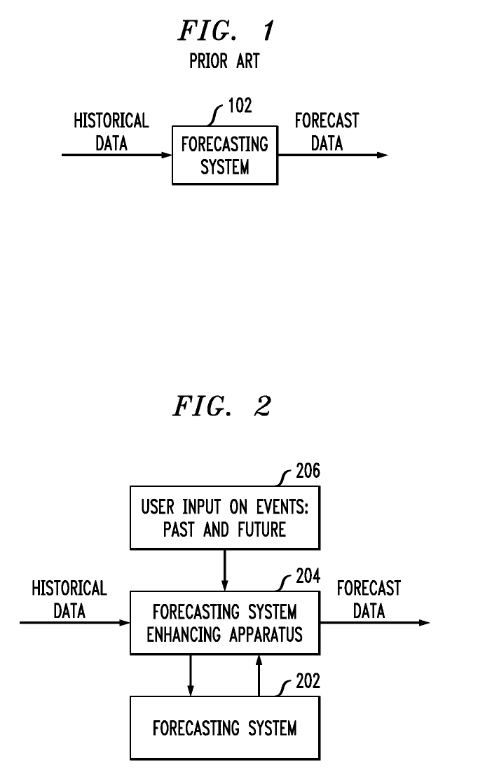

Traditionally, time series modeling, analysis and forecasting methods assume that all the information is contained in the observed sample points. Typically, a generative function is derived from such sample points. This is illustrated in FIG. 1, wherein a prior art forecasting system 102 takes historical data as an input and develops the forecast based solely on such data. However, presence of external events which might have impacted the sample is totally ignored. Instead, the time series is considered to be non-stationary or with concept drift. In accordance with one or more embodiments of the invention, such series are systematically studied, to mine external events, to understand their impact, and finally to predict future values, again, in the presence of such events.

One or more instances of the invention advantageously provide, for example, savings through improved operational efficiencies and better resource planning, and/or can be tailored to provide per-item recommendations to manage inventories for retail stores in the presence of events such as holidays and back-to-school.

An exemplary apparatus, according to an aspect of the invention, enhances forecasting systems to take into account the effects of external events in the context of resource planning. In particular, with reference to FIG. 2, the forecasting system enhancing apparatus 204 takes, as input, historical time-series data and user labeling of parts of the time-series with known past-events of several types. It also takes as input labeling of the future with anticipated events. The labeling of past and future events is indicated at block 206. The apparatus 204 extracts the observable effects of the labeled past-events. It discovers at least some of the missed events in the historical data using statistical techniques and obtains user labeling for the newly identified events. The user can also refine the events if needed. Apparatus 204 then interacts with a forecasting system 202 to develop the forecast data, based on both the historical data and the user input from block 206.

From the observed effects of past-events and those of newly identified events, the system learns, for each type of event T, a parameterized function in the form f(T), which captures the “typical” effect of events of type T. The system decomposes the historical data into two parts: those that are induced as the effects of the past-events (known and identified) and the remaining data capturing the evolution of the time-series in the absence of events. The system constructs the forecast by superimposing the forecast of the time-series analysis with the typical effects corresponding to the events labeled in the future.

Aspects of the invention thus provide an apparatus 204 to enhance forecasting systems (such as 202) to take into account the effects of external events in the context of resource planning. One input is the historical data. Furthermore, one or more embodiments implement automatic and/or semi-automatic event detection from the historical data; for example, using an events detector 310 to be discussed further below. In addition, one or more instances employ an events learner 312, to be discussed further below, for learning of representative event models. Apparatus 204 supplies the normalized historical data to the forecasting system 202, takes the forecasted normalized data from the forecasting system 202, and reconstructs the forecasted data by superimposing the future events on the normalized forecasted data supplied by the forecasting system 202. In one or more embodiments, an events re-constructor 314, to be discussed below, is employed. The event-augmented forecasted data is output from apparatus 204 as the forecast data.

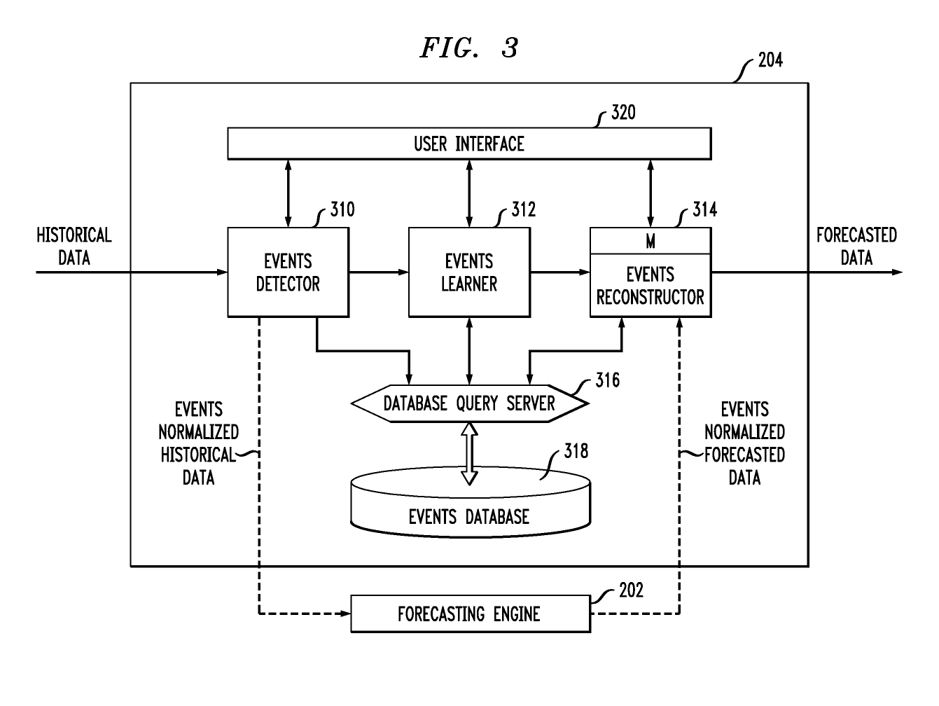

FIG. 3 shows details of a non-limiting exemplary embodiment of apparatus 204. Events detector 310 takes the historical data as input, and interacts with a user via user interface 320. Events detector 310 stores detected events in events database 318 via database query server 316. Furthermore, events detector 310 provides detected events to events learner 312, which also interacts with events database 318 via query server 316. In addition, events detector 310 provides events-normalized historical data to forecasting engine 202 which in turn returns events-normalized forecasted data to events re-constructor 314. M in block 314 is storage (can be a flat file also) which stores the possible future events that can happen as provided by the user. These events are not the event models, these are physical events that the user foresees to happen in the future. Thus, M stores the physical event names, and possible times when those can happen. It can also store clues from users about the severity (if users have any knowledge).

Note block 202 is referred to herein equivalently as a forecasting system and as a forecasting engine. The forecasting system or engine 202 can be implemented, for example, using known systems such as autoregressive models. There are many statistical forecasting systems based on AR (auto-regression), ARMA (auto-regression moving average), ARIMA (auto-regression integrated moving average) models. There are also forecasting models based on neural networks and other techniques in the literature. Given the teachings herein, the skilled artisan will be able to adapt one or more known techniques to implement aspects of the invention.

Note that aspects of the invention contemplate both the system 204 per se and the system 204 together with the forecasting engine 202.

Events learner 312 and events re-constructor 314 also interact with the user via user interface 320; re-constructor 314 also interacts with database 318 via query server 316. In addition to such interaction with the user and the database 318, re-constructor 318 also takes learned events as inputs from events learner 312 (and as noted above, receives events-normalized forecasted data from engine 202), and outputs the forecasted data which, as noted, is obtained by superimposing the future events on the normalized forecasted data supplied by the engine 202. In one or more embodiments, future events are derived from the stored annotated event models and the physical future events (M) as supplied by the user.

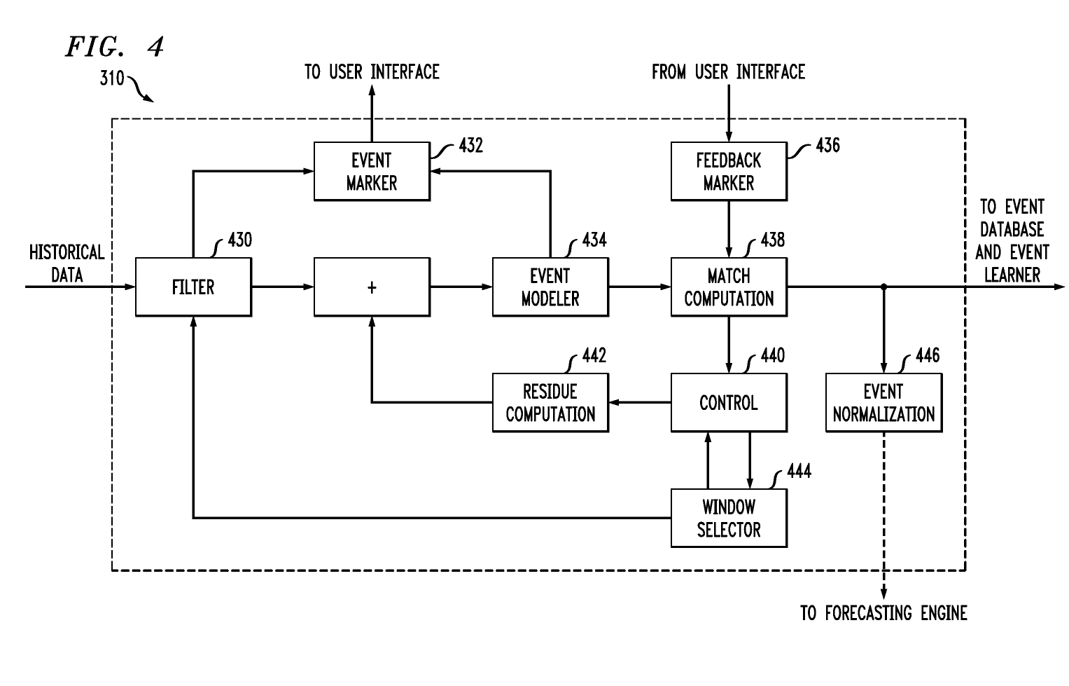

With reference to FIG. 4, events detector 310 can function automatically and/or semi-automatically. In particular, filter 430 can perform automatic detection of different regions in the historical data, and can employ an initial window. The detected regions are modeled by event modeler 434, using semi-parametric models, such that each region representative of an event is characterized by one (or a collection of) representative models. In one or more embodiments, model all the regions, not just the ones that correspond to external events. Wherever it is observed that that there is a contribution from some kernel event with a height greater than a certain threshold, consider that some event has occurred there. Then the user is asked about what kind of physical event had happened during that period. If there is no such event, then that particular instance is ignored. If the user is able to provide some clue about any physical event, then that particular kernel event (or the combination of kernels) are annotated accordingly and stored against that physical event. Here, the modeling is referred to as semi-parametric because this is a combination of parametric (kernel models) and non-parametric (instances of specific regions). In one or more embodiments:
(i) Carry out the filtering
(ii) Then find out the baseline activity and any trend (if present) (This is modeling the entire filtered output)
(iii) Eliminate the baseline activity and the trend; the leftover is due to events
(iv) Compare with a certain non-zero threshold and any activity (filtered output-baseline—trend) less than the threshold is deleted (insignificant) and the rest is considered for modeling
(v) Then segment the activity (after thresholding) along the time-axis and find out the contiguous segments with non-zero activity. Then model each segment separately.

Filter 430 and event modeler 434 provide input to event marker 432, which communicates the detected events to the user interface 320 for optionally obtaining user input for the purpose of further refinement of the detected regions, as indicated at feedback marker 436. In match computation block 438, the automatically detected regions are compared with any user input. The necessary parameter(s) (for example, window size) for detecting the regions can be refined to enhance functionality of filter 430 in filtering the historical data. Thus, control block 440 can receive input from match computation block 438, and can interact with window selector 444 to obtaining the optimal window size, by comparing user feedback and the automatically detected regions; selector 444 then updates filter 430. In addition, residue computation block 442 further models the residue (the difference between user feedback and the automatically detected regions) using semi-parametric models; its output may be added to that of filter 430 which sum is then taken as the input to event modeler 434.

After the time-series is filtered, the semi-parametric models are fitted on the filtered output to model the events. The semi-parametric curve is then matched with the original filtered output. The first filtered output is obtained with a certain larger window size. The window size is then reduced to capture finer level details. The finer level output is then compared with a first semi-parametric model, and the residue is further modeled by the same procedure (semi-parametric modeling). At every step, a user can provide feedback about his or her satisfaction and the residue computation stops when the user agrees. In this process, certain events with very short durations may not be captured automatically because that may result in noisy models. In such a scenario, the user can manually add those relevant regions and those specific regions are then modeled further by the apparatus.

The event models are output from match computation block 438 and stored in the events database 318 as well as being sent to the events learner 312. In event normalization block 446, the historical data is normalized with respect to the modeled events, and such normalized data is then sent to the forecasting engine 202.

Events detector 310 can be configured with a variety of capabilities. For example, outlier detection capability may be provided in one or more embodiments. Detector 310 may assume and/or learn a distribution of “normal behavior.” Outliers are detected based on the assumption that the underlying generative model of the distribution is not perturbed. The presence of events can change the underlying model itself. A Survey of Outlier Detection Methodology, Hodge and Austin, Artificial Intelligence Review, 2004 is a survey that points to some existing outlier detection algorithms. The outlier detection methods can be used as a special instantiation of detector 310.

In another example, change point detection capability may be provided in detector 310, in one or more embodiments. Such capability detects points of change in time series, and can be used to segment the series into homogenous sub-segments. Each sub-segment can be further analyzed to learn the effect of external events. Detection of Abrupt Change: Theory and Application, Michele Basseville and Igor V. Nikiforov, ISBN 0-13-126780-9, previously published by Prentice Hall, Inc. points to some existing change point detection algorithms. The change point detection methods can be used as a special instantiation of detector 310.

In yet another example, concept drift capability may be provided in detector 310, in one or more embodiments. Such capability detects changes in underlying data distribution, and typically assumes that the signal is short term stationary, and uses some form of windowing mechanism. Given the right window size, the method can be used to detect parts of a signal which get impacted by external events. The Problem of Concept Drift: Definitions and Related Work, Alexey Tsymbal, Technical Report# TCD-CS 2004-15, Computer Science Department, Trinity College, Dublin points to some existing concept of drift detection algorithms. The rift detection methods can be used as a special instantiation of detector 310.

In yet another example, unusual and/or rare pattern detection capability may be provided in detector 310, in one or more embodiments. Such capability uses a sliding window over the whole signal and finds the sub-sequence which is farthest away from all sub-sequences. This type of capability may not be suitable for all embodiments of the invention, inasmuch as it assumes a stationary signal, and also assumes that after an “unusual” sub-sequence, the signal starts to behave similarly as it was before the occurrence of the sub-sequence. HOT SAX: Finding most unusual time series subsequence: Algorithms and Applications, Keogh et al. ICDM 2005. points to some existing shape/pattern detection algorithms. The shape and/or pattern detection methods can be used as a special instantiation of detector 310.

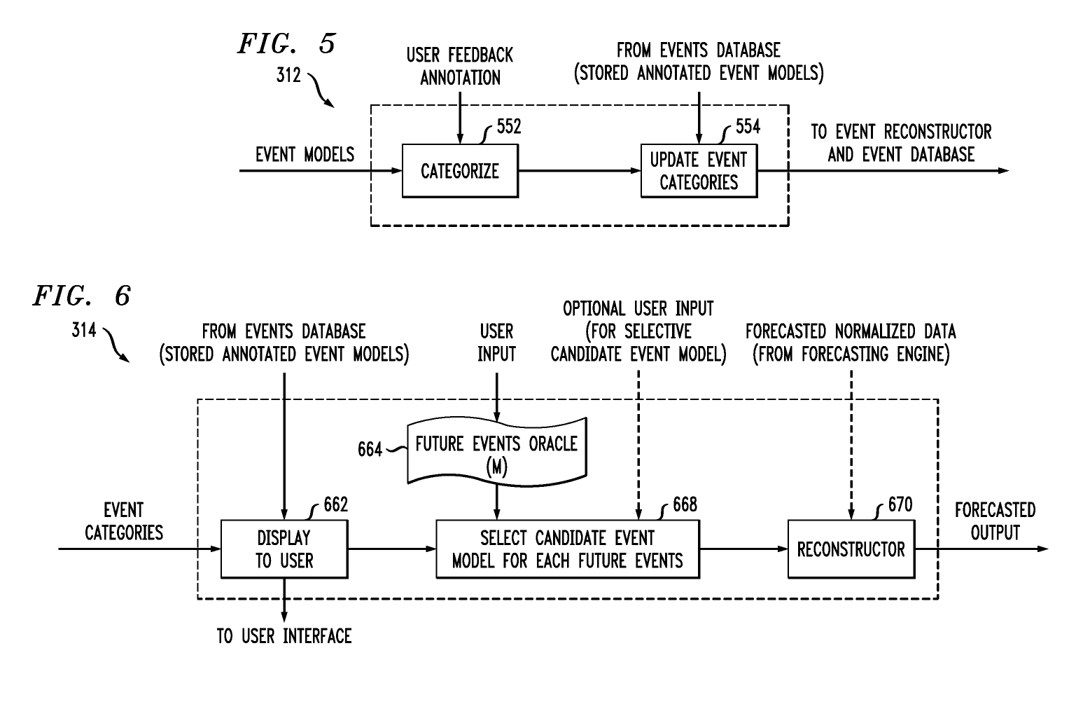

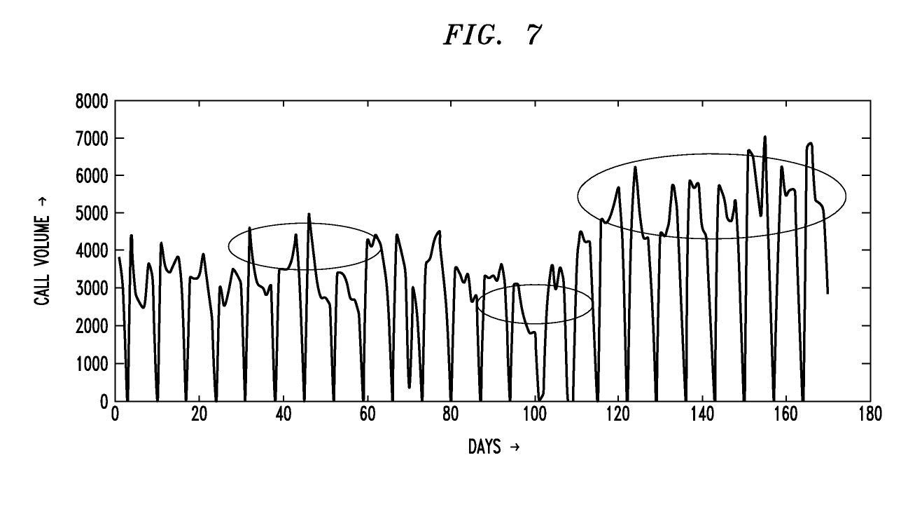

With reference to FIG. 5, events learner 312 learns of representative event models that have been developed as described herein. Learner 312 obtains user annotation of the past events detected, and partitions the event models according to the annotated categories, as indicated at block 552. Within each group of event models representative of one particular physical event, one cluster of event models or a group of clusters of event models are obtained, subject to certain criteria measure, as indicated by the input to block 554 labeled “FROM EVENTS DATBASE.” The candidate event models for each physical event are represented. In case a physical event is represented by a single cluster of event models, such representation can be by one candidate event. In case a physical event is represented by more than one cluster of event models, such representation can be by a ranked subset of candidate events, the ranking being performed by certain criterion measure. As per block 554, the event categories already stored in the database are updated with the newly detected event models, and the output from block 554 is also routed to the event re-constructor 670. The “certain criteria measure” is the criteria used in shape matching. The (new) event is assigned to a cluster (event type) such that the shapes are similar. It is possible that the new event's shape is similar to multiple clusters. In such a case, multiple models are assigned to an event, which are again ranked based on a measure of shape similarity.

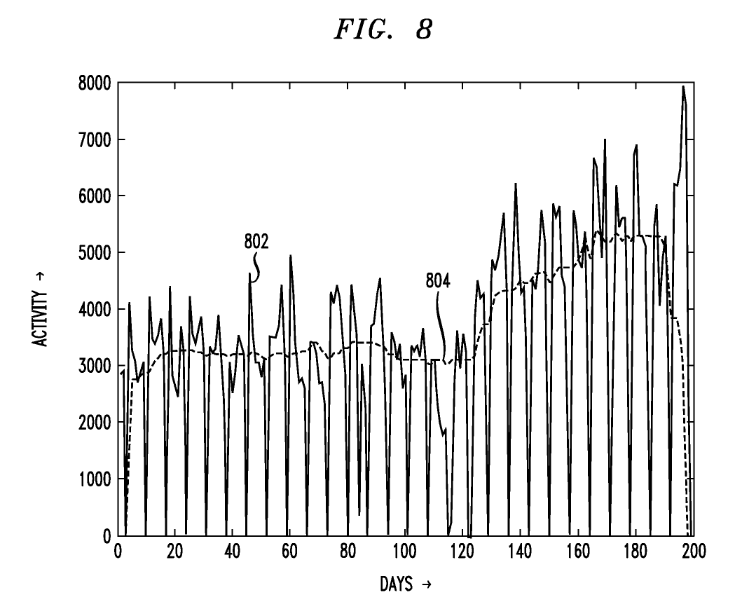

With reference to FIG. 6, events re-constructor 314 reconstructs the forecasted data by displaying (preferably all) physical events in the past, and the corresponding event models, as indicated at block 662. User input is accepted about the future possible events, and stored in an internal file, as shown at block 664. The best candidate event model is selected for each future physical event specified by the user, as indicated at block 668. In particular, with optional input from the user, a new event model is specified by the user for a future physical event which is not in the events database, or for which an existing event model is not satisfying the user. A model can be developed for a future physical event not in the events database using, for example, a user interface such as a graphical user interface (GUI). Re-constructor 670 accepts the normalized forecasted data from the forecasting engine 202, and superimposes the effects of event models corresponding to the future physical events on the normalized forecasted data obtained from engine 202, to obtain the forecasted output.

FIG. 7 presents non-limiting exemplary data (call volume versus time) related to the detection of outliers. However, outliers are by nature random, and do not perturb the underlying prediction model (by definition). External events are deterministic. Therefore, the presence of external events changes the underlying generative model (at least locally).

In one or more embodiments of the invention, region detection is advantageous. As noted, events are deterministic and can change the characteristics of the underlying generative model. Events can be viewed as phenomena causing different regions of activities in the time-series. Events can, in at least some instances, be detected by identifying different regions in the time-series. For example, one possibility is to segment the time-series such that each segment is homogeneous in the sense that each segment has one invariant generative model.

When events detector 310 carries out region detection, it identifies different regions of activities. For example, median filtering (popular in the image processing domain) can be applied to time-series, by the skilled artisan, given the teachings herein. FIG. 8 shows raw data 802 for activity versus time, as well as median-filtered data, with a window of 30, labeled as 804.

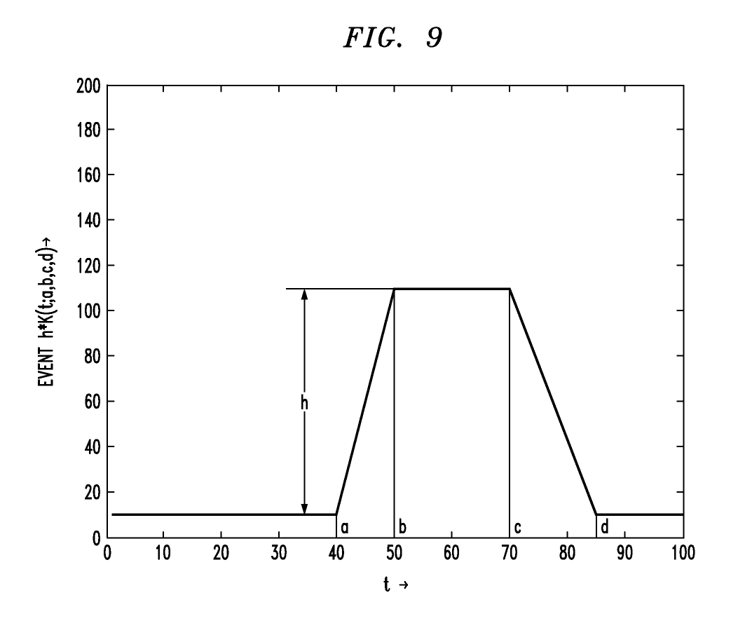

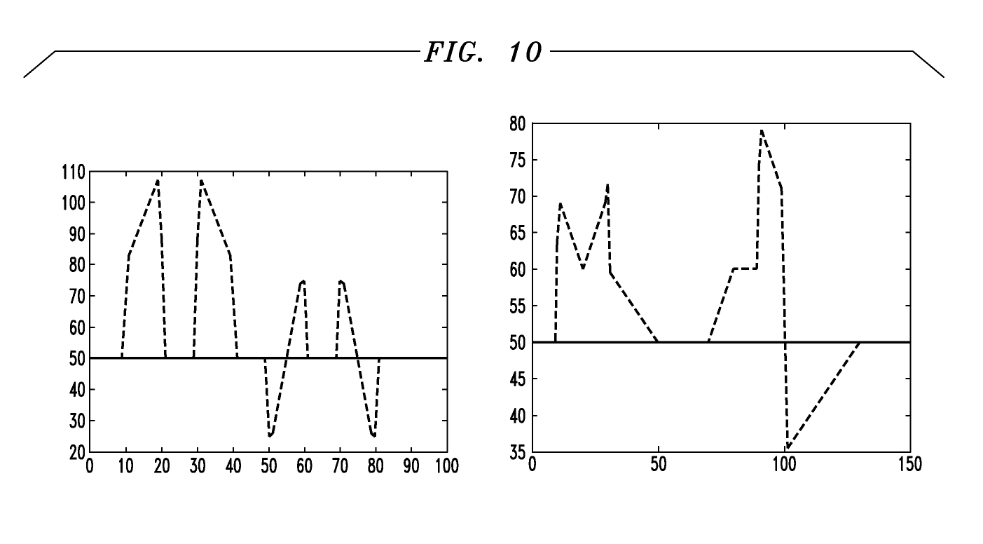

With reference to FIG. 9, modeling may be carried out in events detector 310 as follows. Define a kernel event shape K(t,a,b,c,d) such that a set of events are described as:

$$g ( t ) = α + β t + {\sum }_{i} {h}_{i} K ( t ; {a}_{i} , {b}_{i} , {c}_{i} , {d}_{i} ) \qquad ( 1 )$$

where:

g(t) is the underlying event,

α is a constant representing the baseline activity,

β is a constant to represent the linear trend, and

hᵢ are the scaling factors of the kernel events.

The observed time-series (z(t)) can be represented as:

z(t)=f(x(t−1), x(t−2), . . . , x(t−w);Q)*g(t) (2)

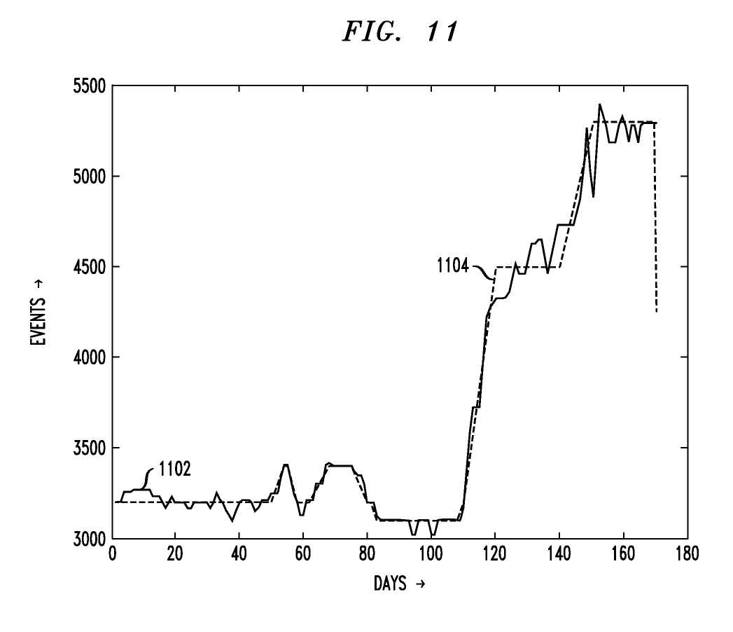

FIG. 9 depicts a kernel event h*K(t;a,b,c,d) where h=100, a=40, b=50, c=70, and d=85. Any piecewise linear events can be modeled with this kernel event. Non-limiting examples are shown on FIG. 10.

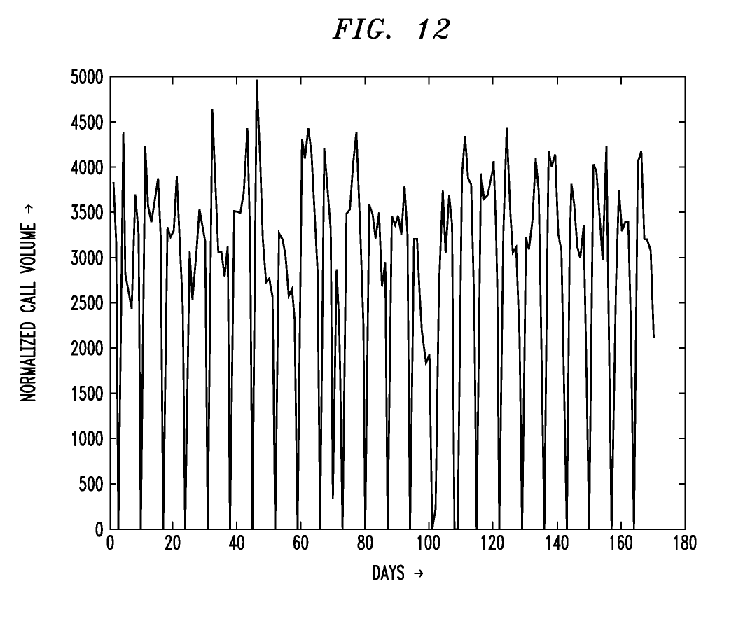

As shown in FIG. 11, the output of median filtering of the time-series (window=30), labeled 1102, is modeled by the piecewise linear kernel events 1104.

Additional comments will now be presented re modeling with events detector 310. Once the output of median filtering is modeled by the kernel events, each region modeled by a piecewise linear event can be identified. A user can be queried about the specific event. The parameters a,b,c,d represent the duration and nature of the event. The parameter h represents the severity of the event. As in the previous example, it may not be possible to represent a single event by one kernel event model; rather it can be represented by cascading more than one kernel event model. From the feedback of the user, the parameter values a,b,c,d,h or the set of parameter values for a specific event can be estimated. If the only instance of a particular event is available in the history, then these parameters define the nature; if more than one instance of a particular event is available then the average or mean characteristics of these parameters can approximate that particular event.

An automatic event modeling process can be initiated by estimating the parameters with respect to minimizing the discrepancy between the observed median and fitted model. Mathematically, let y(t) represent the observed median. The task is to estimate the parameters by minimizing the functional:

$$L ( α , β , h , {a}_{i} , {b}_{i} , {c}_{i} , {d}_{i} ) = {\sum }_{t} {( y ( t ) - α - β t - {\sum }_{i} {h}_{i} K ( t ; {a}_{i} , {b}_{i} , {c}_{i} , {d}_{i} ) )}^{2} \qquad ( 3 )$$

This is a complex, non-convex optimization problem, to which existing deterministic optimization algorithms cannot be applied. Appropriate approaches include meta-heuristics, randomized search (simulated annealing, evolutionary algorithms) and the like. Standard solvers exist in the market and/or in open source, which, given the teachings herein, can be used to solve such systems to implement aspects of the invention.

Alpha (α), in one or more embodiments, is determined by using support vector regression; and beta (β) is assumed to be zero; that is, there is no trend. Once alpha is determined, each event is modeled locally using stochastic optimization. The entire process of determining alpha, beta, and the event parameters can be found together by using stochastic optimization.

Additional comments will now be presented re normalization with events detector 310. Once the events are modeled, the observable time-series can be normalized with respect to the modeled events such that in the normalized outcome the modeled events are not present. In the data, assume for illustrative purposes that there is no inherent trend, that is, beta (β)=0, such that the normalized observable can be obtained as:

$$\hat{z} ( t ) = \frac{α z ( t )}{α + {\sum }_{i} {h}_{i} K ( t ; {a}_{i} , {b}_{i} , {c}_{i} , {d}_{i} )} \qquad ( 4 )$$

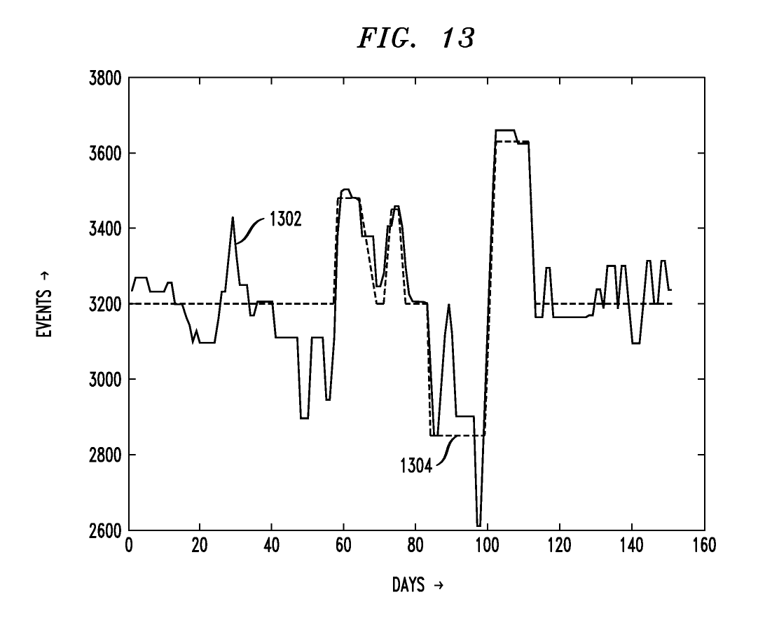

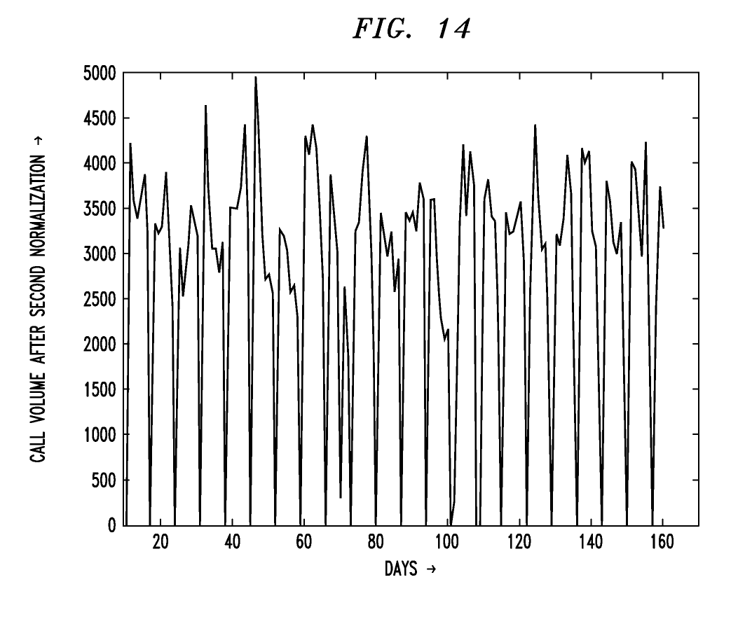

Modeled events at window=30 are normalized, and the outcome shown in FIG. 12 is obtained, which presents normalized call volume versus time after eliminating events at window=30. Note that all events may not be detected at a larger window. After normalizing the observables, events can be further detected at a smaller window. For example, a multi-resolution approach can be taken. FIG. 13 shows events detected modeled at window=20 (curve 1302) on the previous normalized outcome 1304.

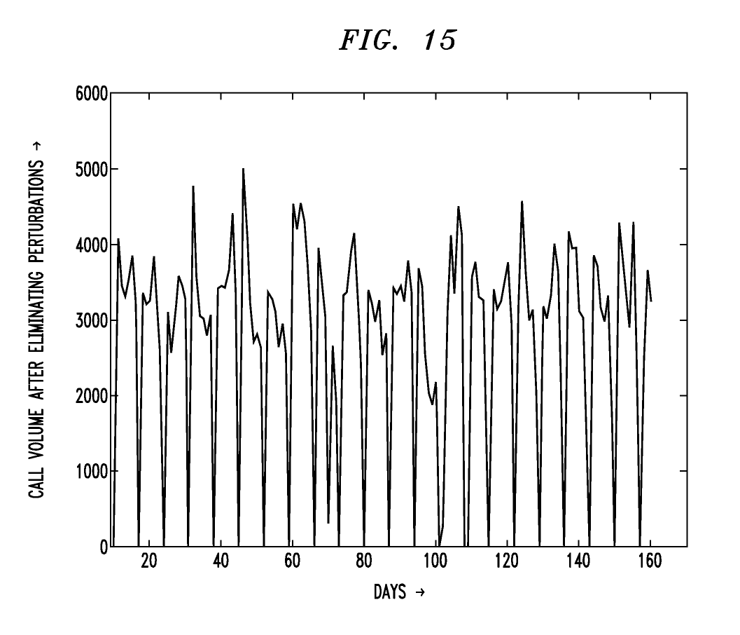

FIG. 14 shows normalized call volume after a second normalization (that is, after eliminating events at window=20). In some instances, a multi-resolution approach can be adapted, wherein events are detected by iteratively reducing the window size. In a non-limiting example, all residual events after window=20 are ignored and the median of the residual is made constant at α. The final outcome without any events is depicted in FIG. 15, which presents normalized call volume after eliminating all perturbations, as a function of time.

Additional comments will now be presented re events learner 312. In a non-limiting example, learner 312 can be implemented as a table look-up. Such an approach may be particularly advantageous, for example, where there is limited data availability. In at least some cases, each physical event is associated with only one modeled event.

Additional comments will now be presented re events re-constructor 314. The future events are superimposed on the forecasted normalized data, subject to the fact that the future event models are estimated from the past history. The events are superimposed subject to the mathematical form:

$$\begin{matrix}z ( t ) = f ( x ( t - 1 ) , x ( t - 2 ) , … , x ( t - w ) ; Q ) * g ( t ) & ( 5 ) \\ g ( t ) = {\sum }_{i} {h}_{i} K ( t ; {a}_{i} , {b}_{i} , {c}_{i} , {d}_{i} ) & ( 6 )\end{matrix}$$

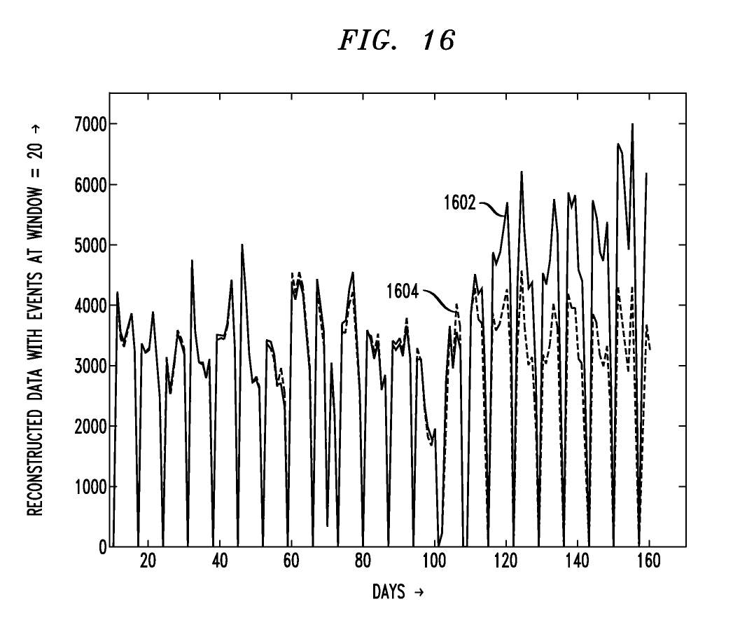

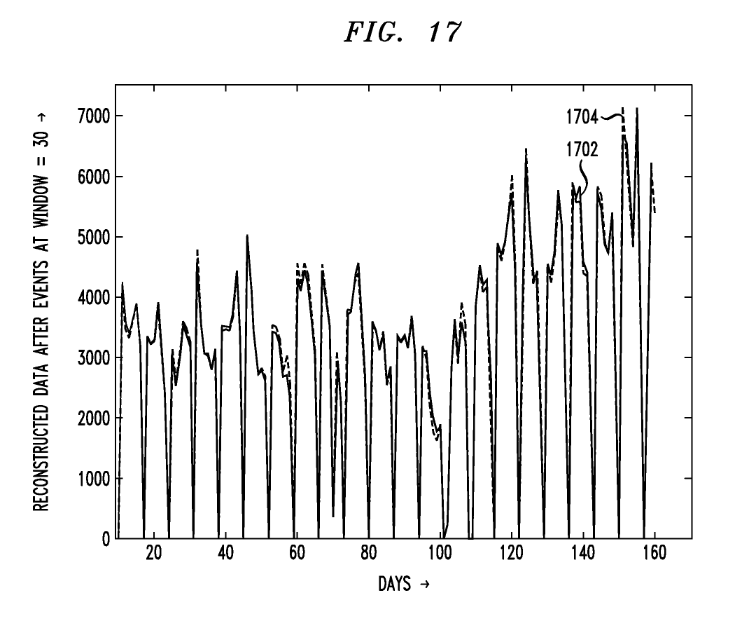

FIG. 16 shows an example of time-series reconstruction. The detected model events are imposed on the normalized outcome with no event, that is, with constant median. The original data is labeled as 1602, while the outcome after superimposing the events at window=20 is labeled as 1604. FIG. 17 is similar to FIG. 16, with the original data labeled as 1702 and the outcome after superimposing the events at window=30 labeled as 1704.

It should be noted that unlike prior art general demand forecasting techniques, one or more embodiments of the invention consider the effect of external events. Aspects of the invention provide automatic detection of different time spans in the history where some possible events have occurred, and associate these possible events with the actual physical events by querying the user. Additional aspects include learning the possible event effects, that is, if some physical event had happened (say a long vacation or lowering the price by a competitor) then how the event (in the mathematical form) will look. This information can be used for the future forecast where a user provides input that a physical event has happened. In addition, aspects of the invention also include the utility of identifying certain events in the history manually which can play a causal role in changing the forecast. In short, one or more embodiments of the invention require much less knowledge from the user about the changeability of the forecasted data; rather, a more generic specification of the physical event is employed, which a user can flexibly change to make different kinds of forecasts. Further, in some instances, the user is relieved of providing all possible physical events that happened in the past; the user provides information about physical events in the past only when queried by the system.

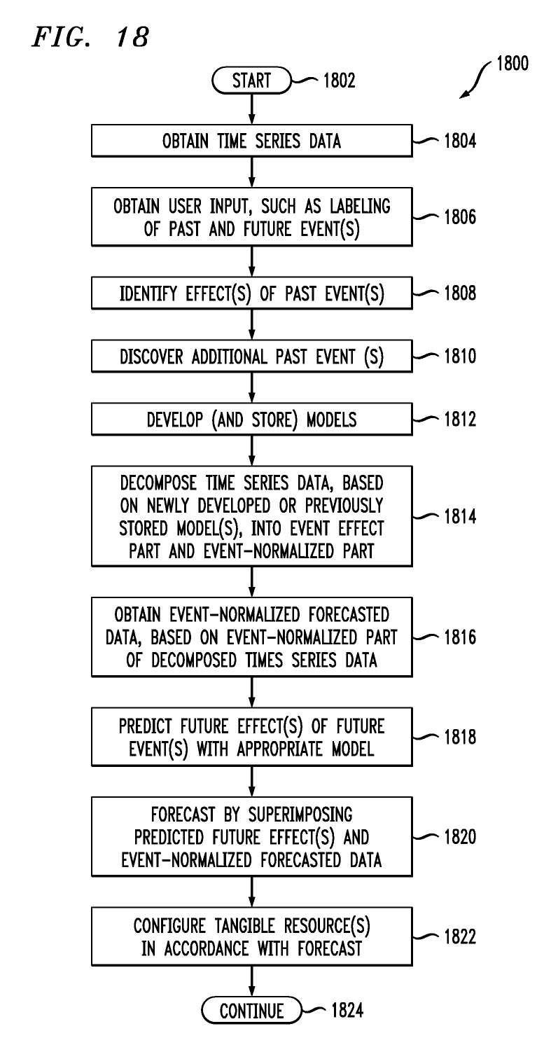

Reference should now be had to flow charts 1800 and 1900 of FIGS. 18 and 19. Processing begins at block 1802. It will be appreciated that, in general terms, a method for forecasting includes obtaining as input at least a first future external event, as in block 1806; for example, using user interface 320. Further, the method includes predicting at least one future effect of the at least one future external event, as in block 1818; for example, by reconstructor 314 applying a stored model to the future external event stored in M. The at least first future external event is similar to at least a first past external event. Yet further, the method includes forecasting future utilization of at least one tangible resource by superimposing events-normalized forecasted data and the at least one predicted future effect of the at least one future event similar to the at least first past external event, as in block 1820; this step can also be carried out by reconstructor 314.

In an optional but preferred approach, the method includes step 1804 of obtaining historical time series data indicative of past utilization of at least one tangible resource, step 1808 of identifying at least one effect of the at least first past external event in the historical time series data, and step 1812 of developing a first representative event model for the at least first past external event (for example, with events detector 310). The first representative event model captures at least one typical effect of events similar to the at least first past external event, and the predicting of the at least one future effect in step 1818 is carried out with the first representative event model. A further optional step 1814 includes decomposing the historical time series data into (i) a first part induced as the at least one typical effect of the at least first past external event identified in the identifying step 1808 and (ii) a second part capturing evolution of the time series absent the at least first past external event. The second part includes events-normalized historical data. This can also be carried out with detector 310. Yet a further optional step 1816 includes obtaining, from a forecasting engine 202, based on the events-normalized historical data of step 1814, events-normalized forecasted data. This can be carried out with reconstructor 314.

In at least some embodiments, a further step 1822 includes configuring the at least one tangible resource in accordance with the forecast future utilization. This could be carried out, for example, by a human manager or operator, and could be facilitated by suitable display of the forecast future utilization.

In some cases, step 1806 includes obtaining user labeling of the at least first past external event, such as with interface 320, and the identifying of the at least one effect of the at least first past external event in step 1808 is carried out by detector 310 based on the user labeling of the at least first past external event. Furthermore, in some cases step 1806 includes obtaining user labeling of the at least first future external event similar to the at least first past external event; for example, using user interface 320 interacting with M portion of block 314.

Additional optional steps include steps 1810 and 1812, which can also be carried out with detector 310. Step 1810 includes detecting at least a second past external event in the historical time series data. Step 1806 can include, in such case, obtaining user labeling for the at least second past external event. Step 1812 includes developing a second representative event model for the at least second past external event. The second representative event model captures at least one typical effect of events similar to the at least second past external event. In such case, step 1806 can also include obtaining input indicative of at least a second future external event similar to the at least second past external event; and step 1818 can include predicting, with the second representative event model, at least one future effect of the at least second future external event similar to the at least second past external event. In such cases, step 1814 includes decomposing the historical time series data into (i) the first part, the first part being induced as the at least one typical effect of the at least first past external event and the at least one typical effect of the at least second past external event and (ii) the second part, the second part capturing evolution of the time series absent the at least first past external event and the at least second past external event. Furthermore, in such instances, step 1820 includes superimposing the events-normalized forecasted data, the predicted at least one future effect of the at least first future event similar to the at least first past external event, and the at least one future effect of the at least second future external event similar to the at least second past external event.

In one or more embodiments, steps 1810 and 1812 can be carried out with event detector 310, and can include carrying out subroutine 1900 in FIG. 19. After beginning at block 1902, step 1904 includes filtering the historical time series data, using a filter with an initial window, to detect a plurality of regions in the historical time series data. Step 1906 includes modeling, with a parametric model, the detected regions. Decision block 1908 includes comparing the parametric model to the user labeling for the at least second past external event. Step 1914 and the return arrow returning to prior to block 1904 are indicative of repeating the filtering, modeling, and comparing steps, with refinements to the initial window, until satisfactory modeling is obtained, to develop the second representative event model. Attainment of satisfactory modeling is depicted at block 1910. Control can be returned to the main program at block 1912.

Step 1906 can be carried out, for example, with equation (1). Step 1814 can be carried out, for example, with equation (4).

In some instances, step 1812 of developing and storing models can include using events learner 312 to update an event database 318 to reflect, for example, the second representative event model.

This paragraph addresses various aspects that can be implemented, for example, with event re-constructor 314. In at least some instances, step 1806 can be repeated to obtain input indicative of a plurality of additional future external events. Furthermore, step 1818 can be repeated as follows: for those of the plurality of additional future external events similar to the at least first past external event, predict, with the first representative event model, at least one future effect of each of the plurality of additional future external events similar to the at least first past external event. For those of the plurality of additional future external events that are not similar to the at least first past external event, repeat step 1812 to develop at least one additional representative event model. The at least one additional representative event model captures at least one typical effect of events similar to the at least one of the plurality of additional future external events not similar to the at least first past external event. Repeat step 1818 to predict, with the at least one additional representative event model, at least one future effect for the at least one of the plurality of additional future external events not similar to the at least first past external event. As noted, a model can be developed for a future physical event not in the events database using, for example, a user interface such as a graphical user interface (GUI).

### Exemplary System and Article of Manufacture Details

A variety of techniques, utilizing dedicated hardware, general purpose processors, firmware, software, or a combination of the foregoing may be employed to implement the present invention or components thereof. One or more embodiments of the invention, or elements thereof, can be implemented in the form of a computer product including a computer usable medium with computer usable program code for performing the method steps indicated. Furthermore, one or more embodiments of the invention, or elements thereof, can be implemented in the form of an apparatus including a memory and at least one processor that is coupled to the memory and operative to perform exemplary method steps.

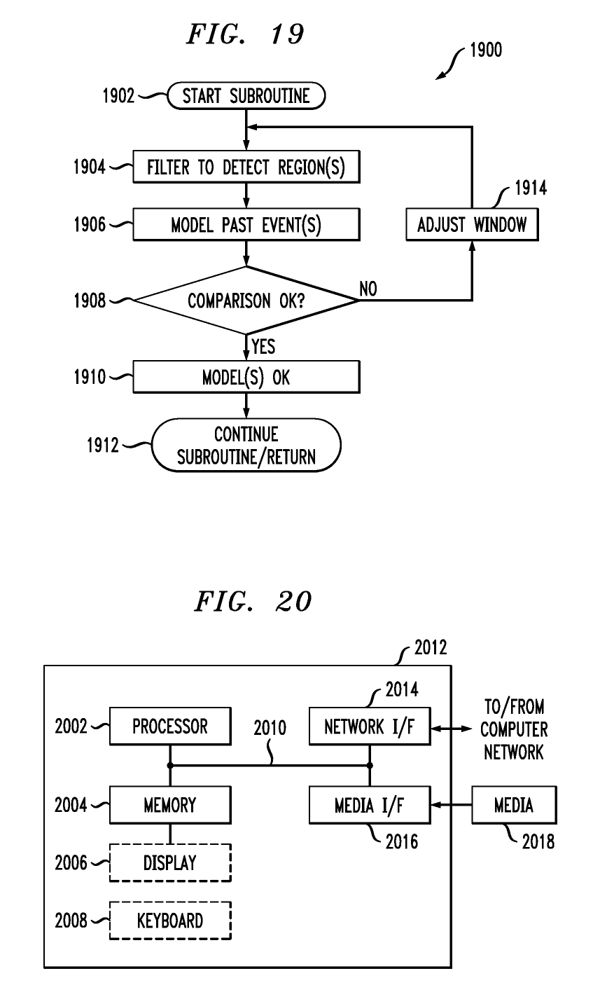

One or more embodiments can make use of software running on a general purpose computer or workstation. With reference to FIG. 20, such an implementation might employ, for example, a processor 2002, a memory 2004, and an input/output interface formed, for example, by a display 2006 and a keyboard 2008. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, one or more mechanisms for inputting data to the processing unit (for example, mouse), and one or more mechanisms for providing results associated with the processing unit (for example, printer). The processor 2002, memory 2004, and input/output interface such as display 2006 and keyboard 2008 can be interconnected, for example, via bus 2010 as part of a data processing unit 2012. Suitable interconnections, for example via bus 2010, can also be provided to a network interface 2014, such as a network card, which can be provided to interface with a computer network, and to a media interface 2016, such as a diskette or CD-ROM drive, which can be provided to interface with media 2018.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and executed by a CPU. Such software could include, but is not limited to, firmware, resident software, microcode, and the like.

Furthermore, the invention can take the form of a computer program product accessible from a computer-usable or computer-readable medium (for example, media 2018) providing program code for use by or in connection with a computer or any instruction execution system. For the purposes of this description, a computer usable or computer readable medium can be any apparatus for use by or in connection with the instruction execution system, apparatus, or device. The medium can store program code to execute one or more method steps set forth herein.

The medium can be an electronic, magnetic, optical, electromagnetic, infrared, or semiconductor system (or apparatus or device) or a propagation medium. Examples of a tangible computer-readable storage medium include a semiconductor or solid-state memory (for example memory 2004), magnetic tape, a removable computer diskette (for example media 2018), a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor 2002 coupled directly or indirectly to memory elements 2004 through a system bus 2010. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards 2008, displays 2006, pointing devices, and the like) can be coupled to the system either directly (such as via bus 2010) or through intervening I/O controllers (omitted for clarity).

Network adapters such as network interface 2014 may also be coupled to the system to enable the data processing system to become coupled to other data processing systems or remote printers or storage devices through intervening private or public networks. Modems, cable modem and Ethernet cards are just a few of the currently available types of network adapters.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments of the invention have been described herein with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a tangible computer-readable storage medium that can direct a computer or other programmable data processing apparatus to function in a particular manner, such that the instructions stored in the computer-readable medium produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Furthermore, it should be noted that any of the methods described herein can include an additional step of providing a system comprising distinct software modules embodied on a tangible computer readable storage medium; the modules can include any or all of the components shown in FIGS. 2-6 (for example, an events detector module, an events learner module, and events reconstructor module, and so on including sub-modules). The method steps can then be carried out using the distinct software modules and/or sub-modules of the system, as described above, executing on a hardware processor. Further, a computer program product can include a tangible computer-readable storage medium with code adapted to be executed to carry out one or more method steps described herein, including the provision of the system with the distinct software modules.

In any case, it should be understood that the components illustrated herein may be implemented in various forms of hardware, software, or combinations thereof; for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

It will be appreciated and should be understood that the exemplary embodiments of the invention described above can be implemented in a number of different fashions. Given the teachings of the invention provided herein, one of ordinary skill in the related art will be able to contemplate other implementations of the invention. Indeed, although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method for forecasting, said method comprising:
obtaining as input at least a first future external event;
predicting at least one future effect of said at least one future external event, said at least first future external event being similar to at least a first past external event; and
forecasting future utilization of at least one tangible resource by superimposing events-normalized forecasted data and said at least one predicted future effect of said at least one future external event similar to said at least first past external event.

2. The method of claim 1, further comprising:
obtaining historical time series data indicative of past utilization of at least one tangible resource;
identifying at least one effect of said at least first past external event in said historical time series data;
developing a first representative event model for said at least first past external event, said first representative event model capturing at least one typical effect of events similar to said at least first past external event, said predicting of said at least one future effect being carried out with said first representative event model;
decomposing said historical time series data into (i) a first part induced as said at least one typical effect of said at least first past external event identified in said identifying step and (ii) a second part capturing evolution of said time series absent said at least first past external event, said second part comprising events-normalized historical data; and
obtaining, from a forecasting engine, based on said events-normalized historical data, events-normalized forecasted data.

3. The method of claim 2, further comprising configuring said at least one tangible resource in accordance with said forecast future utilization.

4. The method of claim 2, further comprising obtaining user labeling of said at least first past external event, wherein said identifying of said at least one effect of said at least first past external event is carried out based on said user labeling of said at least first past external event.

5. The method of claim 4, wherein said obtaining of said input indicative of said at least first future external event similar to said at least first past external event comprises obtaining user labeling of said at least first future external event similar to said at least first past external event.

6. The method of claim 4, further comprising:
detecting at least a second past external event in said historical time series data;
obtaining user labeling for said at least second past external event;
developing a second representative event model for said at least second past external event, said second representative event model capturing at least one typical effect of events similar to said at least second past external event;
obtaining input indicative of at least a second future external event similar to said at least second past external event; and
predicting, with said second representative event model, at least one future effect of said at least second future external event similar to said at least second past external event;
wherein:
said step of decomposing said historical time series data comprises decomposing said historical time series data into (i) said first part, said first part being induced as said at least one typical effect of said at least first past external event and said at least one typical effect of said at least second past external event and (ii) said second part, said second part capturing evolution of said time series absent said at least first past external event and said at least second past external event; and
said step of forecasting said future utilization of said at least one tangible resource comprises superimposing said events-normalized forecasted data, said predicted at least one future effect of said at least first future event similar to said at least first past external event, and said at least one future effect of said at least second future external event similar to said at least second past external event.

7. The method of claim 6, wherein said steps of detecting said at least second past external event in said historical time series data and developing said second representative event model comprise:
filtering said historical time series data, using a filter with an initial window, to detect a plurality of regions in said historical time series data;
modeling, with a parametric model, said detected regions;
comparing said parametric model to said user labeling for said at least second past external event; and
repeating said filtering, modeling, and comparing steps, with refinements to said initial window, until satisfactory modeling is obtained, to develop said second representative event model.

8. The method of claim 7, wherein said modeling with said parametric model is carried out in accordance with:
$$g ( t ) = α + β t + {\sum }_{i} {h}_{i} K ( t ; {a}_{i} , {b}_{i} , {c}_{i} , {d}_{i} )$$
where:
K(t,a,b,c,d) is a kernel event shape;
g(t) is said at least second past external event;
α is a constant representing baseline activity;
β is a constant to represent a linear trend; and
hᵢ are scaling factors of given kernel events.

9. The method of claim 8, wherein, in said step of decomposing said historical time series data by decomposing said historical time series data into said first part and said second part:
said historical time series data is denoted as z(t),
β=0, and
said second part is obtained in accordance with:
$$\hat{z} ( t ) = \frac{α z ( t )}{α + {\sum }_{i} {h}_{i} K ( t ; {a}_{i} , {b}_{i} , {c}_{i} , {d}_{i} )} .$$

10. The method of claim 6, further comprising updating an event database to reflect said second representative event model.

11. The method of claim 1, further comprising:
obtaining input indicative of a plurality of additional future external events;
for those of said plurality of additional future external events similar to said at least first past external event, predicting, with said first representative event model, at least one future effect of each of said plurality of additional future external events similar to said at least first past external event; and
for those of said plurality of additional future external events not similar to said at least first past external event:
developing at least one additional representative event model for at least one of said plurality of additional future external events not similar to said at least first past external event, said at least one additional representative event model capturing at least one typical effect of events similar to said at least one of said plurality of additional future external events not similar to said at least first past external event; and
predicting, with said at least one additional representative event model, at least one future effect for said at least one of said plurality of additional future external events not similar to said at least first past external event.

12. A computer program product comprising a tangible computer readable storage medium including computer usable program code for forecasting, said computer program product including:
computer usable program code for obtaining as input at least a first future external event;
computer usable program code for predicting at least one future effect of said at least one future external event, said at least first future external event being similar to at least a first past external event; and
computer usable program code for forecasting future utilization of at least one tangible resource by superimposing events-normalized forecasted data and said at least one predicted future effect of said at least one future external event similar to said at least first past external event.

13. The computer program product of claim 12, further comprising:
computer usable program code for obtaining historical time series data indicative of past utilization of at least one tangible resource;
computer usable program code for identifying at least one effect of said at least first past external event in said historical time series data;
computer usable program code for developing a first representative event model for said at least first past external event, said first representative event model capturing at least one typical effect of events similar to said at least first past external event, said predicting of said at least one future effect being carried out with said first representative event model;
computer usable program code for decomposing said historical time series data into (i) a first part induced as said at least one typical effect of said at least first past external event identified in said identifying step and (ii) a second part capturing evolution of said time series absent said at least first past external event, said second part comprising events-normalized historical data; and
computer usable program code for obtaining, from a forecasting engine, based on said events-normalized historical data, events-normalized forecasted data.

14. The computer program product of claim 13, further comprising computer usable program code for obtaining user labeling of said at least first past external event, wherein said computer usable program code for identifying of said at least one effect of said at least first past external event carries out said identifying based on said user labeling of said at least first past external event.

15. The computer program product of claim 14, wherein said computer usable program code for obtaining of said input indicative of said at least first future external event similar to said at least first past external event comprises computer usable program code for obtaining user labeling of said at least first future external event similar to said at least first past external event.

16. The computer program product of claim 14, further comprising:
computer usable program code for detecting at least a second past external event in said historical time series data;
computer usable program code for obtaining user labeling for said at least second past external event;
computer usable program code for developing a second representative event model for said at least second past external event, said second representative event model capturing at least one typical effect of events similar to said at least second past external event;
computer usable program code for obtaining input indicative of at least a second future external event similar to said at least second past external event; and
computer usable program code for predicting, with said second representative event model, at least one future effect of said at least second future external event similar to said at least second past external event;
wherein:
said computer usable program code for decomposing said historical time series data comprises computer usable program code for decomposing said historical time series data into (i) said first part, said first part being induced as said at least one typical effect of said at least first past external event and said at least one typical effect of said at least second past external event and (ii) said second part, said second part capturing evolution of said time series absent said at least first past external event and said at least second past external event; and
said computer usable program code for forecasting said future utilization of said at least one tangible resource comprises computer usable program code for superimposing said events-normalized forecasted data, said predicted at least one future effect of said at least first future event similar to said at least first past external event, and said at least one future effect of said at least second future external event similar to said at least second past external event.

17. An apparatus for forecasting, said apparatus comprising:
a memory; and
at least one processor, coupled to said memory, and operative to:
obtain as input at least a first future external event;
predict at least one future effect of said at least one future external event, said at least first future external event being similar to at least a first past external event; and
forecast future utilization of at least one tangible resource by superimposing events-normalized forecasted data and said at least one predicted future effect of said at least one future external event similar to said at least first past external event.

18. The apparatus of claim 17, wherein said processor is further operative to:
obtain historical time series data indicative of past utilization of at least one tangible resource;
identify at least one effect of said at least first past external event in said historical time series data;
develop a first representative event model for said at least first past external event, said first representative event model capturing at least one typical effect of events similar to said at least first past external event, said predicting of said at least one future effect being carried out with said first representative event model;
decompose said historical time series data into (i) a first part induced as said at least one typical effect of said at least first past external event identified in said identifying step and (ii) a second part capturing evolution of said time series absent said at least first past external event, said second part comprising events-normalized historical data; and
obtain, from a forecasting engine, based on said events-normalized historical data, events-normalized forecasted data.

19. The apparatus of claim 18, wherein:
said processor is further operative to obtain user labeling of said at least first past external event;
said processor is operative to identify said at least one effect of said at least first past external event based on said user labeling of said at least first past external event; and
said processor is further operative to obtain said input indicative of said at least first future external event similar to said at least first past external event by obtaining user labeling of said at least first future external event similar to said at least first past external event.

20. The apparatus of claim 19, wherein said processor is further operative to:
detect at least a second past external event in said historical time series data;
obtain user labeling for said at least second past external event;
develop a second representative event model for said at least second past external event, said second representative event model capturing at least one typical effect of events similar to said at least second past external event;
obtain input indicative of at least a second future external event similar to said at least second past external event; and
predict, with said second representative event model, at least one future effect of said at least second future external event similar to said at least second past external event;
wherein:
said processor is operative to decompose said historical time series data by decomposing said historical time series data into (i) said first part, said first part being induced as said at least one typical effect of said at least first past external event and said at least one typical effect of said at least second past external event and (ii) said second part, said second part capturing evolution of said time series absent said at least first past external event and said at least second past external event; and
said processor is operative to forecast said future utilization of said at least one tangible resource by superimposing said events-normalized forecasted data, said predicted at least one future effect of said at least first future event similar to said at least first past external event, and said at least one future effect of said at least second future external event similar to said at least second past external event.
